(19) United States
(12) Patent Application Publication
(10) Pub. No.: US 2020/0407638 A1
(43) Pub. Date: Dec. 31, 2020

(54) METHOD FOR PRODUCING CHOLESTERIC LIQUID CRYSTAL FILM

(71) Applicant: FUJIFILM Corporation, Tokyo (JP)

(72) Inventor: Hiroshi INADA, Kanagawa (JP)

(73) Assignee: FUJIFILM Corporation, Tokyo (JP)

(21) Appl. No.: 17/019,377

(22) Filed: Sep. 14, 2020

Related U.S. Application Data
(63) Continuation of application No. PCT/JP2019/011563, filed on Mar. 19, 2019.

(30) Foreign Application Priority Data
Mar. 19, 2018 (JP) 2018-050798

(51) Int. Cl. C09K 19/04; C09K 19/58; C09K 19/56

(52) U.S. Cl. CPC C09K 19/04; C09K 19/586; C09K 2019/2078; C09K 2219/03; C09K 2019/0448; C09K 19/56

(57) ABSTRACT

The present invention provides a method for producing a cholesteric liquid crystal film capable of producing a cholesteric liquid crystal film which is formed into a predetermined shape without cracks and exhibits a high modulus of elasticity. The method for producing a cholesteric liquid crystal film according to the present invention includes step 1 of forming a coating film which includes a liquid crystal compound A having a first reactive group and a second reactive group that is different from the first reactive group or which includes a liquid crystal compound B having the first reactive group and a liquid crystal compound C having the second reactive group, step 2 of forming a cholesteric liquid crystalline phase in the coating film, step 3 of allowing the first reactive group to react to cure the coating film, step 4 of forming the coating film obtained in the step 3, and step 5 of allowing the second reactive group to react to produce a cholesteric liquid crystal film.

### CROSS-REFERENCE TO RELATED APPLICATIONS

This application is a Continuation of PCT International Application No. PCT/JP2019/011563 filed on Mar. 19, 2019, which claims priority under 35 U.S.C. § 119(a) to Japanese Patent Application No. 2018-050798 filed on Mar. 19, 2018. Each of the above applications is hereby expressly incorporated by reference, in its entirety, into the present application.

### BACKGROUND OF THE INVENTION

### 1. Field of the Invention

The present invention relates to a method for producing a cholesteric liquid crystal film.

### 2. Description of the Related Art

A film formed by fixing a cholesteric liquid crystalline phase (hereinafter, also referred to as “cholesteric liquid crystal film”) is known as a layer that has a property of selectively reflecting either right-handed circularly polarized light or left-handed circularly polarized light in a specific wavelength range, and has been developed for various applications.

For example, JP2002-536529A discloses a cholesteric liquid crystal film obtained by polymerizing a liquid crystal compound having a polymerizable group.

### SUMMARY OF THE INVENTION

In recent years, a cholesteric liquid crystal film formed into a predetermined shape has been desired. As long as a three-dimensional shape such as a curved surface can be given to a cholesteric liquid crystal film, the cholesteric liquid crystal film can be laminated to articles of various shapes without a gap.

In addition, from the viewpoint of handleability, it is also desired that a cholesteric liquid crystal film exhibit a high modulus of elasticity.

As a result of producing a cholesteric liquid crystal film using the liquid crystal compound disclosed in JP2002-536529A and evaluating the characteristics thereof, the present inventors have found that there is a problem that cracks occur in a case where the film is tried to be formed into a desired shape while a high modulus of elasticity is exhibited.

In view of the above situation, an object of the present invention is to provide a method for producing a cholesteric liquid crystal film capable of producing a cholesteric liquid crystal film that is formed into a predetermined shape without cracks and exhibits a high modulus of elasticity.

The present inventors have conducted intensive studies on the above object, and have thus found that the object can be achieved by carrying out a stepwise curing treatment.

That is, it has been found that the above object can be achieved by the following constitution.

(1) A method for producing a cholesteric liquid crystal film comprising: step 1 of forming a coating film which includes a liquid crystal compound A having a first reactive group and a second reactive group that is different from the first reactive group or which includes a liquid crystal compound B having the first reactive group and a liquid crystal compound C having the second reactive group;

step 2 of forming a cholesteric liquid crystalline phase in the coating film;

step 3 of allowing the first reactive group to react to cure the coating film;

step 4 of forming the coating film obtained in the step 3; and

step 5 of allowing the second reactive group to react to produce a cholesteric liquid crystal film.

(2) The method for producing a cholesteric liquid crystal film according to (1), in which the first reactive group and the second reactive group are each independently selected from the group consisting of an acryloyl group, a methacryloyl group, an oxetanyl group, an epoxy group, a thietanyl group, a thioepoxy group, a carboxyl group, a mercapto group, an isocyanate group, an isothiocyanate group, an aziridinyl group, a pyrrole group, a vinyl group, an allyl group, a fumarate group, a cinnamoyl group, an oxazoline group, a hydroxyl group, an alkoxysilyl group, a hydrosilyl group, and an amino group.

(3) The method for producing a cholesteric liquid crystal film according to (1) or (2), in which the coating film in the step 1 includes a chiral agent.

(4) The method for producing a cholesteric liquid crystal film according to any one of (1) to (3), in which the reaction of the second reactive group is a radical polymerization reaction.

(5) The method for producing a cholesteric liquid crystal film according to any one of (1) to (4), in which the second reactive group is an acryloyl group or a methacryloyl group.

(6) The method for producing a cholesteric liquid crystal film according to any one of (1) to (5), in which the reaction of the first reactive group is a cationic polymerization reaction, a Michael addition reaction, a hydrosilylation reaction, or an ene-thiol reaction.

(7) The method for producing a cholesteric liquid crystal film according to any one of (1) to (6), in which the first reactive group is an oxetanyl group, an epoxy group, a thietanyl group, a thioepoxy group, a mercapto group, an acryloyl group, or a methacryloyl group.

(8) The method for producing a cholesteric liquid crystal film according to any one of (1) to (7), in which the coating film in the step 1 includes the liquid crystal compound A having the first reactive group and the second reactive group that is different from the first reactive group.

According to the present invention, it is possible to provide a method for producing a cholesteric liquid crystal film capable of producing a cholesteric liquid crystal film that is formed into a predetermined shape without cracks and exhibits a high modulus of elasticity.

### DESCRIPTION OF THE PREFERRED EMBODIMENTS

Hereinafter, the present invention will be described in detail. In this specification, a numerical range expressed by using “to” means a range including numerical values described before and after “to” as a lower limit value and an upper limit value, respectively.

In the present invention, visible light is light in a wavelength visible to human eyes among electromagnetic waves, and indicates light in a wavelength range of 380 to 780 nm. Ultraviolet light is light in a wavelength range of 10 nm or more and less than 380 nm, and infrared light is light in a wavelength range of more than 780 nm.

In addition, in the visible light, light in a wavelength range of 420 to 490 nm is blue (B) light, light in a wavelength range of 495 to 570 nm is green (G) light, and light in a wavelength range of 620 to 750 nm is red (R) light.

The features of a production method according to an embodiment of the present invention are that a stepwise curing treatment is carried out twice, and a forming treatment is carried out between a first stage curing treatment and a second stage curing treatment.

The cholesteric liquid crystal film disclosed in JP2002-536529A exhibits a high modulus of elasticity since the cholesteric liquid crystal film is obtained by completely curing a liquid crystal compound having a plurality of polymerizable groups. However, since the cholesteric liquid crystal film itself is excessively hard, cracks are generated in a case where the film is formed into a predetermined shape.

In contrast, according to the production method of the embodiment of the present invention, since two types of reactive groups are used, first, only one of the reactive groups is allowed to react by a first stage curing treatment to produce a semi-cured film. Since the obtained film is relatively easily stretched, the film can be formed into a predetermined shape. Then, the film formed into a predetermined shape is subjected to the second stage curing treatment to allow the other reactive group to react, and thus a cholesteric liquid crystal film, which is formed into a predetermined shape without cracks and exhibits a high modulus of elasticity, can be obtained.

The production method according to the embodiment of the present invention includes steps 1 to 5 described below.

Hereinafter, the procedure of each step will be described in detail.

<Step 1>

Step 1 is a step of forming a coating film which includes a liquid crystal compound A having a first reactive group and a second reactive group that is different from the first reactive group or which includes a liquid crystal compound B having the first reactive group and a liquid crystal compound C having the second reactive group. By carrying out this step, a coating film to be subjected to a curing treatment is formed. By this step, a coating film including the liquid crystal compound A or a coating film including the liquid crystal compound B and the liquid crystal compound C is formed.

Hereinafter, first, the materials used in this step will be described in detail.

(Liquid Crystal Compound)

The liquid crystal compound A has a first reactive group and a second reactive group that is different from the first reactive group.

The types of the first reactive group and the second reactive group are not particularly limited, and known reactive groups can be used. Among these, from the viewpoint of excellent reactivity, it is preferable that the first reactive group and the second reactive group are each independently selected from the group consisting of an acryloyl group, a methacryloyl group, an oxetanyl group, an epoxy group, a thietanyl group, a thioepoxy group, a carboxyl group, a mercapto group, an isocyanate group, an isothiocyanate group, an aziridinyl group, a pyrrole group, a vinyl group, an allyl group, a fumarate group, a cinnamoyl group, an oxazoline group, a hydroxyl group, an alkoxysilyl group, a hydrosilyl group, and an amino group.

The number of the first reactive groups of the liquid crystal compound A is not particularly limited, and is preferably 1 to 3, more preferably 1 or 2, and even more preferably 1 from the viewpoint of easily applying forming to a cholesteric liquid crystal film (hereinafter, also referred to as “CL film”).

The number of the second reactive groups of the liquid crystal compound A is not particularly limited, and is preferably 1 to 3, more preferably 1 or 2, and even more preferably 1 from the viewpoint of imparting hardness to the CL film.

The types of the reactions of the first reactive group and the reaction of the second reactive group are not particularly limited, and known reactions are adopted. Examples thereof include a radical polymerization reaction, a cationic polymerization reaction, a Michael addition reaction, a hydrosilylation reaction, an ene-thiol reaction, a condensation reaction, a ring-opening reaction (for example, a ring-opening reaction of an oxetanyl group, a thietanyl group, an epoxy group, or a thioepoxy group), and a dimerization reaction (for example, photodimerization reaction, specifically, a photodimerization reaction between cinnamoyl groups or the like).

From the viewpoint of easily applying forming to the CL film, the reaction of the first reactive group is preferably a cationic polymerization reaction, a Michael addition reaction, a hydrosilylation reaction, or an ene-thiol reaction.

More specifically, the first reactive group is preferably an oxetanyl group, an epoxy group, a thietanyl group, a thioepoxy group, a carboxyl group, a mercapto group, an isocyanate group, an isothiocyanate group, an aziridinyl group, a pyrrole group, a vinyl group, an allyl group, a fumarate group, a cinnamoyl group, an oxazoline group, a hydroxyl group, an alkoxysilyl group, a hydrosilyl group, or an amino group, and more preferably an oxetanyl group, an epoxy group, a thietanyl group, a thioepoxy group, a mercapto group, an acryloyl group, or a methacryloyl group.

From the viewpoint that the modulus of elasticity of the CL film becomes higher, the reaction of the second reactive group is preferably a radical polymerization reaction.

More specifically, the second reactive group is preferably an acryloyl group or a methacryloyl group.

Examples of a combination of the first reactive group and the second reactive group include (epoxy group: (meth)acryloyl group), (oxetanyl group: (meth)acryloyl group), (epoxy group: mercapto group), (oxetanyl group: mercapto group), (epoxy group: hydrosilyl group), and (oxetanyl group: hydrosilyl group).

In addition, the group on the left side in the above ( ) represents the first reactive group, and the group on the right side represents the second reactive group. In addition, the (meth)acryloyl group represents an acryloyl group or a methacryloyl group.

The type of the liquid crystal compound A is not particularly limited, and may be of a rod-like type (rod-like liquid crystal compound) or a disc-like type (disk-like liquid crystal compound, discotic liquid crystal compound).

The liquid crystal compound A is preferably a compound represented by Formula (1).

X-L-M-L-Y Formula(1)

X represents a first reactive group. Y represents a second reactive group. The definitions of the first reactive group and the second reactive group are as described above.

L's each independently represent a single bond or a divalent linking group. The divalent linking group is not particularly limited, and for example, the divalent linking group may be any one selected from the group consisting of —O—, —CO—, —NR^{A}—, and a divalent hydrocarbon group, or a group obtained by combining two or more thereof. R^{A} represents a hydrogen atom or an alkyl group.

Examples of the divalent hydrocarbon group include an alkylene group, an alkenylene group (for example, —CH═CH—), an alkynylene group (for example, —C≡C—), and an arylene group (for example, phenylene group). The alkylene group may be linear, branched, or cyclic. The number of carbon atoms thereof is preferably 1 to 10, more preferably 1 to 6, and even more preferably 1 to 4.

M represents a divalent mesogenic group.

The mesogenic group is a functional group having rigidity and alignment. The mesogenic group may be a rod-like mesogenic group or a disc-like mesogenic group. The rod-like mesogenic group means a mesogenic group having a structure in which the main skeleton portion is linear, and the disk-like mesogenic group means a mesogenic group having a structure in which the main skeleton portion is radially spread.

As the structure of the mesogenic group, more specifically, a structure formed by linking a plurality of groups selected from the group consisting of an aromatic ring group (an aromatic hydrocarbon ring group or an aromatic heterocyclic group) and an alicyclic group, directly or via a divalent linking group (for example, —CO—, —O—, —CH═CH—, —CH═N—, —N═N—, —C≡C—, —NR^{A}— (R^{A} represents a hydrogen atom or an alkyl group), or a group obtained by combining these groups) may be adopted.

More specifically, examples of the mesogenic group include groups represented by Formula (A).

-(L^{a}-L^{b})ₙ- Formula (A)

L^{a} represents a divalent aromatic ring group or a divalent alicyclic group.

Examples of the divalent aromatic ring group include a divalent aromatic hydrocarbon ring group (for example, a phenylene group) and a divalent aromatic heterocyclic group.

Examples of the divalent alicyclic group include a cyclohexylene group.

L^{b} represents a single bond, —CO—, —O—, —CH═CH—, —CH═N—, —N═N—, —C≡C—, —NR^{A}—, or a group obtained by combining these groups (for example, —CO—O—). R^{A} represents a hydrogen atom or an alkyl group.

n represents an integer of 2 or more. Among these, n preferably represents an integer of 2 to 5, and more preferably represents an integer of 2 or 3.

In a case where the coating film includes the liquid crystal compound A, the content of the liquid crystal compound A is not particularly limited, and is preferably 30 to 99% by mass, and more preferably 50 to 97% by mass with respect to the total mass of the coating film.

The liquid crystal compound B is a compound having a first reactive group. The liquid crystal compound B does not have a second reactive group.

The definition of the first reactive group is as described above.

The number of the first reactive groups contained in the liquid crystal compound B is not particularly limited, and is preferably 1 to 4, and more preferably 2 or 3 from the viewpoint of easily applying forming to the CL film and obtaining a higher modulus of elasticity in the CL film.

The type of the liquid crystal compound B is not particularly limited, and may be of a rod-like type (rod-like liquid crystal compound) or a disc-like type (disc-like liquid crystal compound, discotic liquid crystal compound).

As the liquid crystal compound B, a compound represented by Formula (2) is preferable.

X-L-M-L-X Formula (2)

X represents a first reactive group. The definition of the first reactive group is as described above.

L's each independently represent a single bond or a divalent linking group. The definition of the divalent linking group is the same as the definition of the divalent linking group represented by L in Formula (1).

M represents a divalent mesogenic group. The definition of the mesogenic group is the same as the definition of the mesogenic group represented by M in Formula (1).

The liquid crystal compound C is a compound having a second reactive group. The liquid crystal compound C does not have a first reactive group.

The definition of the second reactive group is as described above.

The number of the second reactive groups included in the liquid crystal compound C is not particularly limited, and is preferably 1 to 4, and more preferably 2 or 3 from the viewpoint of easily applying forming to the CL film and obtaining a higher modulus of elasticity in the CL film.

The type of the liquid crystal compound C is not particularly limited, and may be of a rod-like type (rod-like liquid crystal compound) or a disc-like type (disc-like liquid crystal compound, discotic liquid crystal compound).

As the liquid crystal compound C, a compound represented by Formula (3) is preferable.

Y-L-M-L-Y Formula (3)

Y represents a second reactive group. The definition of the second reactive group is as described above.

L's each independently represent a single bond or a divalent linking group. The definition of the divalent linking group is the same as the definition of the divalent linking group represented by L in Formula (1).

M represents a divalent mesogenic group. The definition of the mesogenic group is the same as the definition of the mesogenic group represented by M in Formula (1).

In a case where the coating film includes the liquid crystal compound B and the liquid crystal compound C, the total content of the liquid crystal compound B and the liquid crystal compound C is not particularly limited, and is preferably 30 to 99% by mass and more preferably 50 to 97% by mass with respect to the total content of the coating film.

A ratio of the content of the liquid crystal compound C to the content of the liquid crystal compound B (liquid crystal compound C/liquid crystal compound B) is not particularly limited, and is preferably 1 to 9, and more preferably 1.5 to 4.

(Other Components)

The coating film may include components other than the liquid crystal compounds A to C.

For example, the coating film may include a curing agent having a third reactive group that reacts with the first reactive group or the second reactive group. For example, in a case where the reaction of the first reactive group is a hydrosilylation reaction and the first reactive group is a vinyl group, a curing agent having a hydrosilyl group (H—Si) can be used together. In this case, in the step 3 described later, the reaction proceeds between the vinyl group that is the first reactive group and the hydrosilyl group that is the third reactive group.

Specifically, it is preferable that the third reactive group of the curing agent reacts with the first reactive group.

The type of the third reactive group of the curing agent is not particularly limited, and the optimum reactive group is selected according to the type of the first reactive group or the second reactive group. For example, a group selected from the group consisting of an acryloyl group, a methacryloyl group, an oxetanyl group, an epoxy group, a thietanyl group, a thioepoxy group, a carboxyl group, a mercapto group, an isocyanate group, an isothiocyanate group, an aziridinyl group, a pyrrole group, a vinyl group, an allyl group, a fumarate group, a cinnamoyl group, an oxazoline group, a hydroxyl group, an alkoxysilyl group, a hydrosilyl group, and an amino group may be used.

Examples of the combination of the first reactive group or the second reactive group and the third reactive group include (vinyl group: hydrosilyl group), ((meth)acryloyl group: mercapto group), (epoxy group: (meth)acryloyl group), ((meth)acryloyl group: epoxy group), (oxetane group: (meth)acryloyl group), and ((meth)acryloyl group: oxetane group).

The group on the left side of the above ( ) represents the first reactive group or the second reactive group, and the group on the right side represents the third reactive group. In addition, the (meth)acryloyl group represents an acryloyl group or a methacryloyl group.

The coating film may include a chiral agent.

The type of chiral agent is not particularly limited. The chiral agent may be liquid crystalline or non-liquid crystalline. The chiral agent can be selected from various known chiral agents (for example, “Liquid Crystal Device Handbook”, Chapter 3, 4-3, Chiral Agents for twisted nematic (TN) and super twisted nematic (STN), p. 199, edited by Japan Society for the Promotion of Science, 142 Committee, 1989). The chiral agent generally includes asymmetric carbon atoms. However, an axially asymmetric compound not containing asymmetric carbon atoms or a planarly asymmetric compound can be used as a chiral agent. Examples of the axially asymmetric compound or the planarly asymmetric compound include binaphthyl, helicene, paracyclophane, and derivatives thereof. The chiral agent may have a polymerizable group.

The chiral agent may be used alone or in combination of two or more thereof.

The content of the chiral agent in the coating film is not particularly limited, and is preferably 0.1 to 30% by mass with respect to the total mass of the liquid crystal compound in the coating film.

The coating film may include a polymerization initiator. Particularly, in a case where the liquid crystal compound has a polymerizable group (for example, a radically polymerizable group or a cationically polymerizable group), the composition preferably includes a polymerization initiator.

As the polymerization initiator, a photopolymerization initiator capable of initiating a polymerization reaction by irradiation with ultraviolet light or visible light is preferable.

As the type of the polymerization initiator, the optimal compound is selected depending on the types of the first reactive group and the second reactive group, and examples thereof include a radical polymerization initiator and a cationic polymerization initiator. For example, in a case where the reaction of the first reactive group is a cationic polymerization reaction and the reaction of the second reactive group is a radical polymerization reaction, the coating film may include both a radical polymerization initiator and a cationic polymerization initiator.

The types of radical polymerization initiator and cationic polymerization initiator are not particularly limited, and known compounds are used.

The total content of the polymerization initiator in the coating film is not particularly limited, and is preferably 0.01 to 20% by mass, and more preferably 0.05 to 8% by mass with respect to the total mass of the liquid crystal compound having a polymerizable group in the coating film.

The coating film may contain an alignment control agent. Since the coating film includes an alignment control agent, a cholesteric liquid crystalline phase can be stably or rapidly formed.

The content of the alignment control agent in the coating film is not particularly limited, and is preferably 0.01 to 10% by mass, and more preferably 0.01 to 5% by mass with respect to the total mass of the liquid crystal compound in the coating film.

The coating film may include other additives such as an antioxidant, an ultraviolet absorbing agent, a sensitizer, a stabilizer, a plasticizer, a chain transfer agent, a polymerization inhibitor, an antifoaming agent, a leveling agent, a thickener, a flame retardant, a surfactant, a dispersant, and a coloring material such as a dye and a pigment.

(Procedure of Step 1)

In the step 1, the procedure is not particularly limited as long as a coating film including the above-described components is formed. However, a method of applying a composition including a predetermined component to form a coating may be used. In a case of forming a coating film including the liquid crystal compound A, a composition X including the liquid crystal compound A is used, and in a case of forming a coating film including the liquid crystal compound B and the liquid crystal compound C, a composition Y including the liquid crystal compound B and the liquid crystal compound C is used.

The composition (composition X and composition Y) may include a solvent.

Examples of the solvent include water and organic solvents. Examples of the organic solvents include amides such as N,N-dimethylformamide; sulfoxides such as dimethyl sulfoxide; heterocyclic compounds such as pyridine; hydrocarbons such as benzene and hexane; alkyl halides such as chloroform and dichloromethane; esters such as methyl acetate, butyl acetate, and propylene glycol monoethyl ether acetate; ketones such as acetone, methyl ethyl ketone, cyclohexanone, and cyclopentanone; ethers such as tetrahydrofuran and 1,2-dimethoxyethane; and 1,4-butanediol diacetate.

The method for applying the above-mentioned composition (composition X and composition Y) is not particularly limited, and examples thereof include a wire bar coating method, a curtain coating method, an extrusion coating method, a direct gravure coating method, a reverse gravure coating method, a die coating method, a spin coating method, a dip coating method, and a spray coating method.

The above composition is usually applied to various supports. The support may be a temporary support that is peeled off after the CL film is formed.

As the support (temporary support), a glass substrate or the like may be used in addition to a plastic film.

An alignment film may be arranged on the surface of the support, if necessary.

The surface of the support may be subjected to a rubbing treatment, if necessary.

After the application, a drying treatment for removing the solvent from the coating film may be carried out, if necessary.

The thickness of the coating film to be formed is not particularly limited, and preferably 1 to 100 μm, more preferably 1 to 50 μm, and even more preferably 2 to 30 μm.

<Step 2>

Step 2 is a step of forming a cholesteric liquid crystalline phase in the coating film. In this step, the liquid crystal compounds (liquid crystal compounds A to C) in the coating film are cholesterically aligned to form a cholesteric liquid crystalline phase.

The method for forming the cholesteric liquid crystalline phase is not particularly limited, and examples thereof include a method of heating the coating film. The optimum heating temperature is selected according to on the type of liquid crystal compound to be used, and is usually often 30° C. to 160° C. and more often 50° C. to 130° C.

The helical pitch length of the cholesteric liquid crystalline phase to be formed can be controlled by adjusting the type of liquid crystal compound, the type of chiral agent, or the concentration of addition thereof

<Step 3>

Step 3 is a step of allowing the first reactive group to react to cure the coating film. In this step, the first reactive group of the liquid crystal compound in the coating film is allowed to react to cure the coating film. In this step, the second reactive group is not allowed to react. That is, the step 3 can be said to be a step of semi-curing the coating film. In the following step, the film obtained in the step 3 is also referred to as “semi-cured film”.

The method for allowing the first reactive group to react varies depending on the type of the first reactive group, and examples thereof include an exposure treatment and a heat treatment.

The wavelength during the exposure treatment is not particularly limited, and examples thereof include ultraviolet light and visible light. During the exposure, the coating film may be exposed through a filter that cuts a predetermined wavelength so that the reaction of the second reactive group does not proceed.

The irradiation energy at the time of exposure is preferably 20 mJ/cm² to 50 J/cm², and more preferably 100 to 1500 mJ/cm².

The exposure may be carried out under heating conditions. The optimum heating temperature is selected depending on the type of liquid crystal compound to be used, and is usually often 30° C. to 160° C. and more often 50° C. to 150° C.

In a case where a heat treatment is used as a method for allowing the first reactive group to react, the optimum heating temperature is selected as a heating temperature depending on the type of the first reactive group, and is usually often 30° C. to 160° C. and more often 50° C. to 150° C.

<Step 4>

Step 4 is a step of forming the coating film obtained in the step 3. In this step, the semi-cured film obtained in the step 3 is formed into a predetermined shape. That is, this step is a step of deforming the semi-cured film obtained in the step 3.

The forming method is not particularly limited, and examples thereof include a thermoforming method. Specific examples of the thermoforming method include vacuum forming, pressure forming, vacuum-pressure forming, insert molding, and blow molding.

As a vacuum forming method, for example, a method in which in a chamber box in which the pressure can be reduced, a film to be treated (corresponding to a semi-cured film in the present invention) is set, the film to be treated is softened by heating in a state where the pressure in the chamber is reduced, the film is pressed to a specific mold, and the pressure in the chamber is returned to the atmospheric pressure may be used.

As a pressure forming method, for example, a method in which in a chamber box in which the pressure can be reduced, a film to be treated is set, in a state where the pressure in the chamber is reduced, the film to be treated is softened by heating and pressurized to deform the film to be treated, and the pressure in the chamber is returned to the atmospheric pressure may be used.

As an insert molding method, for example, a method in which a film to be treated, which is vacuum-formed along an injection molding mold in advance, is set in the mold, a molten resin is injected therein, and the film to be treated is welded to a product while performing injection molding may be used.

Examples of the heating device for the film to be treated during thermoforming include various devices such as an infrared heater, an electric heater, a high frequency induction heating device, a halogen lamp, a microwave generator, a steam generator, and a laser device.

The temperature during thermoforming is not particularly limited, and is preferably 70° C. to 400° C., more preferably 100° C. to 300° C., and even more preferably 120° C. to 250° C.

The heating time is not particularly limited as long as the shape can be changed, and is preferably 0.1 to 30 minutes, more preferably 0.5 to 10 minutes, and even more preferably 1 to 5 minutes.

The shape given to the coating film obtained in the step 3 by forming is not particularly limited, and examples thereof include a three-dimensional shape including a curved surface. That is, for example, in this step, a semi-cured film having a three-dimensional shape including a curved surface is obtained.

In addition, step 5 described below may be carried out using a laminate obtained by forming the coating film obtained in the step 3 according to the shape of a predetermined object to be laminated and laminating the formed coating film and the object to be laminated.

<Step 5>

Step 5 is a step of allowing the second reactive group to react to produce a cholesteric liquid crystal film. In this step, a CL film having a high modulus of elasticity is obtained by allowing the second reactive group to react.

The method of allowing the second reactive group to react varies depending on the type of the second reactive group, and examples thereof include an exposure treatment and a heat treatment.

The wavelength during the exposure treatment is not particularly limited, and examples thereof include ultraviolet light and visible light.

The irradiation energy at the time of exposure is preferably 20 mJ/cm² to 50 J/cm², and more preferably 100 to 1500 mJ/cm².

The exposure may be carried out under heating conditions. The optimum heating temperature is selected depending on the type of liquid crystal compound to be used, and is usually often 30° C. to 160° C. and more often 50° C. to 150° C.

In a case where a heat treatment is used as a method for allowing the second reactive group to react, the optimum heating temperature is selected as the heating temperature depending on the type of the second reactive group, and is usually often 30° C. to 160° C. and more often 50° C. to 150° C.

By the above method, a CL film which is formed into a predetermined shape without cracks and exhibits a high modulus of elasticity is produced.

The obtained CL film corresponds to a film formed by fixing a cholesteric liquid crystalline phase.

The cholesteric liquid crystalline phase has circularly polarized light selective reflectivity that either right-handed circularly polarized light or left-handed circularly polarized light is selectively reflected. Therefore, the CL film also has the circularly polarized light selective reflectivity.

The state in which the cholesteric liquid crystalline phase is “fixed” is a state in which the alignment of the liquid crystal compound in the cholesteric liquid crystalline phase is maintained. More specifically, it is preferable that the state in which the cholesteric liquid crystalline phase is “fixed” is a state in which usually in a temperature range of 0° C. to 50° C., and under severe condition, in a temperature range of −30° C. to 70° C., the layer does not have fluidity, and the fixed alignment form can be maintained continuously without changing the alignment form due to an external field or external force.

The reflection center wavelength of the CL film can be adjusted as appropriate, and may be located in any of a visible light range, an ultraviolet light range, and an infrared light range. The reflection center wavelength is preferably located in the visible light range from the viewpoint of expansion to various applications. In addition, in a case where the reflection center wavelength of the CL film is located in the visible light range, the reflection center wavelength may be located in any of a blue light range, a green light range, and a red light range.

The CL film may be laminated to various objects to be laminated through a pressure sensitive adhesive or an adhesive. Examples of the object to be laminated include vehicle windshields, head-up displays, headlights, decorations inside and outside a company, and lens covers for cameras and the like.

The thickness of the CL film is not particularly limited, and from the viewpoint of handleability, the thickness is preferably 1 to 200 μm, and more preferably 5 to 50 μm.

As a method for increasing the thickness of the CL film, a method of increasing the thickness of the coating film in the step 1 and a method of increasing the thickness of the semi-cured film obtained by repeating the above steps 1 to 3 a plurality of times (for example, twice or more) may be used.

### EXAMPLES

Hereinafter, the present invention will be described in more detail with reference to examples. The materials, the used amount, the ratio, the contents of a treatment, and the procedures of a treatment described in examples below may be suitably modified without departing from the spirit of the present invention. Therefore, the scope of the present invention should not be construed as being limited by the following examples.

<Preparation of Composition 1>

Composition 1 was prepared by mixing the following components.

Liquid crystal compound 1: 1 g

Chiral agent 1: 55 mg

Initiator 1: 10 mg

Initiator 2 (CPI-400PG (manufactured by San-Apro Ltd.)): 14 mg

Alignment agent 1: 0.5 mg

Alignment agent 2: 0.2 mg

Methyl ethyl ketone: 1.09 g

Cyclohexanone: 0.16 g

Liquid Crystal Compound 1 (Compound Represented by Structural Formula Below)

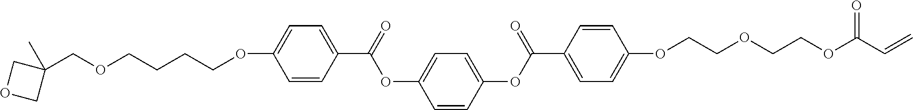 [SMILES: C=CC(=O)OCCOCCOc1ccc(C(=O)Oc2ccc(OC(=O)c3ccc(OCCCCOCC4(C)COC4)cc3)cc2)cc1]

Chiral Agent 1 (Compound Represented by Structural Formula Below)

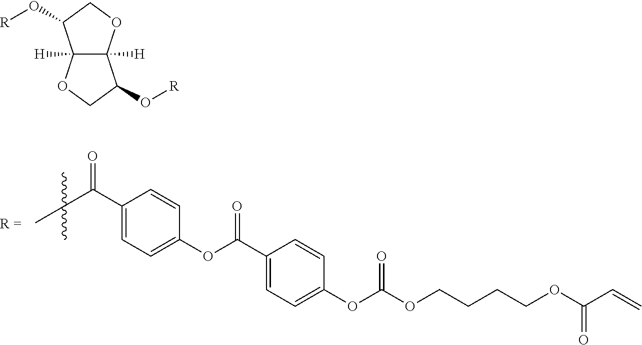

Initiator 1 (Compound Represented by Structural Formula Below)

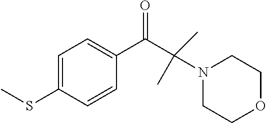 [SMILES: CSc1ccc(C(=O)C(C)(C)N2CCOCC2)cc1]

Alignment Agent 1 (Compound Represented by Structural Formula Below)

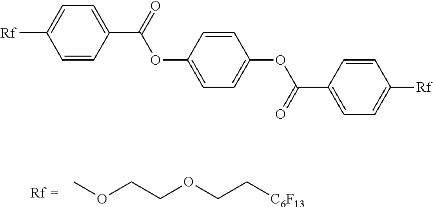

Alignment Agent 2 (Compound Represented by Structural Formula Below)

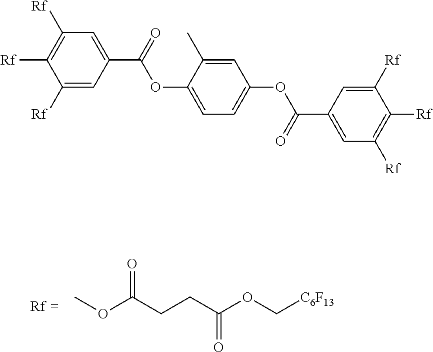

<Preparation of Composition 2>

Composition 2 was prepared by mixing the following components.

Liquid crystal compound 2: 0.7 g

Liquid crystal compound 3: 0.3 g

Chiral agent 1: 55 mg

Initiator 1: 2 mg

Initiator 2 (CPI-100 (manufactured by San-Apro Ltd.)): 14 mg

Alignment agent 1: 0.5 mg

Alignment agent 2: 0.2 mg

Methyl ethyl ketone: 1.09 g

Cyclohexanone: 0.16 g

Liquid Crystal Compound 2 (Compound Represented by Structural Formula Below)

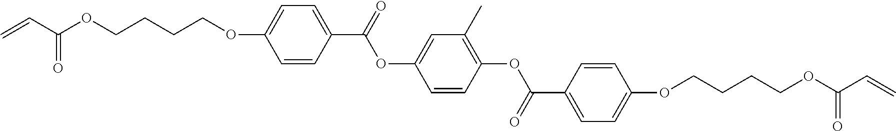 [SMILES: C=CC(=O)OCCCCOc1ccc(C(=O)Oc2ccc(OC(=O)c3ccc(OCCCCOC(=O)C=C)cc3)c(C)c2)cc1]

Liquid Crystal Compound 3 (Compound Represented by Structural Formula Below)

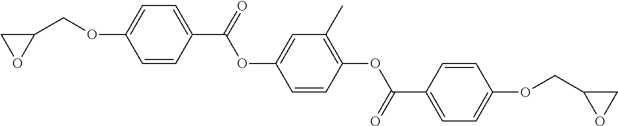 [SMILES: Cc1cc(OC(=O)c2ccc(OCC3CO3)cc2)ccc1OC(=O)c1ccc(OCC2CO2)cc1]

<Preparation of Composition 3>

Composition 3 was prepared by mixing the following components.

Liquid crystal compound 2: 1.0 g

Chiral agent 1: 55 mg

Initiator 1: 2 mg

Alignment agent 1: 0.5 mg

Alignment agent 2: 0.2 mg

Methyl ethyl ketone: 1.09 g

Cyclohexanone: 0.16 g

<Preparation of Composition 4>

Composition 4 was prepared by mixing the following components.

Liquid crystal compound 4: 0.5 g

Liquid crystal compound 5: 0.5 g

Chiral agent 1: 55 mg

Initiator 1: 2 mg

Alignment agent 1: 0.5 mg

Alignment agent 2: 0.2 mg

Methyl ethyl ketone: 1.09 g

Cyclohexanone: 0.16 g

Liquid Crystal Compound 4 (Compound Represented by Structural Formula Below)

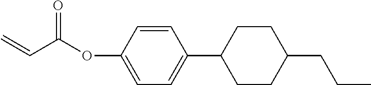 [SMILES: C=CC(=O)Oc1ccc(C2CCC(CCC)CC2)cc1]

Liquid Crystal Compound 5 (Compound Represented by Structural Formula Below)

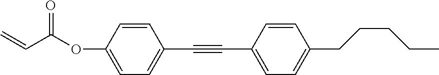 [SMILES: C=CC(=O)Oc1ccc(C#Cc2ccc(CCCCC)cc2)cc1]

### Example 1

A polyethylene terephthalate film (PET, COSMOSHINE A4100) manufactured by Toyobo Co., Ltd. having a thickness of 100 μm was subjected to a rubbing treatment.

Composition 1 was applied to the rubbed surface of the PET film subjected to the rubbing treatment using a wire bar at room temperature, and then a drying treatment was carried out to form a coating film. The thickness of the coating film (dry film) was about 2 to 5 μm.

Next, the PET film on which the coating film was formed was allowed to stand on a hot plate at 100° C. for 1 minute, and the coating film was subjected to a heat treatment in a state of cholesteric liquid crystalline phase.

Next, in an oxygen atmosphere, the coating film in the state of the cholesteric liquid crystalline phase was covered with a wavelength cut filter LU0350 (manufactured by Asahi Bunko Co., Ltd.) and irradiated with ultraviolet rays under a condition of 1000 mJ/cm² at 90° C. to cure the coating film. Thus, a semi-cured film was obtained. The curing treatment allows the oxetanyl group in the liquid crystal compound 1 to react.

An operation of carrying out a curing treatment on a coating film formed by further applying the composition 1 onto the obtained semi-cured film by the same procedure as described above was repeated until the thickness of the semi-cured film to be obtained reached 15 μm or more. Thus, a sample A was obtained.

In this example, “EXECURE 3000-W” (manufactured by HOYA CANDEO OPTRONICS CORPORATION) was used in the curing treatment.

An optical pressure sensitive adhesive film (MSC70; manufactured by MeCan Imaging Inc.) was laminated on the PET film in the obtained sample A, and a peeling film (MRF-25, manufactured by Mitsubishi Plastics, Inc.) was further laminated on the laminated optical pressure sensitive adhesive film.

Next, the film obtained above was temporarily fixed to the convex side of the curved glass (curvature radius: 400 mm) to face the semi-cured film surface side, and was thermoformed from the peeling film side using a commercially available heat gun (set temperature: 200° C.). After the film was neatly formed along the curved glass, the peeling film was peeled off, and the optical pressure sensitive adhesive film was laminated with the concave surface of the curved glass.

Further, the laminated semi-cured film was irradiated with ultraviolet rays of 1000 mJ/cm² at 100° C. in a nitrogen atmosphere to obtain a cured film (cholesteric liquid crystal film). Note that this curing treatment allows the acryloyl group in the liquid crystal compound 1 to react.

The obtained cured film had no cracks and was laminated on the curved glass.

The sample A obtained above was irradiated with ultraviolet rays of 1000 mJ/cm² at 100° C. in a nitrogen atmosphere to produce a sample B for measuring the modulus of elasticity.

### Example 2

A cured film was produced according to the same procedure as in Example 1 except that the composition 2 was used instead of the composition 1. The obtained cured film was had no cracks and was laminated on the curved glass.

Note that the sample B was produced in the same manner as in Example 1.

Further, in Example 2, the epoxy group was allowed to react during the first light irradiation, and the acryloyl group was allowed to react during the second light irradiation.

### Comparative Example 1

A polyethylene terephthalate film (PET, COSMOSHINE A4100) manufactured by Toyobo Co., Ltd. having a thickness of 100 μm was subjected to a rubbing treatment.

The composition 3 was applied onto the rubbed surface of the PET film subjected to the rubbing treatment at room temperature using a wire bar, and then a drying treatment was carried out to form a coating film. The thickness of the coating film (dry film) was about 2 to 5 μm.

Next, the PET film on which the coating film was formed was allowed to stand on a hot plate at 100° C. for 1 minute, and the coating film was subjected to a heat treatment in a state of cholesteric liquid crystalline phase.

Then, in a nitrogen atmosphere, irradiation with ultraviolet rays of 1000 mJ/cm² was performed at 100° C. to obtain a cured film (cholesteric liquid crystal film). The curing treatment allowed the acryloyl group in the liquid crystal compound 2 to react.

The coating film formed by further applying the composition 3 onto the obtained cured film was subjected to a curing treatment by the same procedure as above until the thickness of the cured film to be obtained reached 15 μm or more. Thus, a sample C was obtained.

The obtained sample C was heated to 130° C. and curved to laminate the sample on the concave surface of the curved glass (curvature radius: 400 mm). Cracks in the cured film in the sample C were observed.

### Comparative Example 2

A sample C was obtained according to the same procedure as in Comparative Example 1 except that the composition 4 was used instead of the composition 3. The sample C was heated to 130° C. and curved to laminate the obtained sample C on the concave surface of the curved glass (curvature radius: 400 mm). No crack was observed in the cured film in the sample C, and the sample C formed along the shape of the curved glass could be laminated.

<Measurement of Modulus of Elasticity>

The PET film was peeled off from each of the samples B produced in Examples 1 and 2 and the samples C produced in Comparative Examples 1 and 2, and the modulus of elasticity of each cured film obtained was measured at room temperature using a TENSILON universal material testing machine (RTC-1225A, manufactured by A&D Company, Limited) and evaluated according to the following standards.

“A”: The modulus of elasticity is 1000 MPa or more.

“B”: The modulus of elasticity is less than 1000 MPa.

<Measurement of Elongation at Break>

The PET film was peeled off from each of the samples A produced in Examples 1 and 2 and the samples C produced in Comparative Examples 1 and 2, and the elongation at break of each of the obtained films (the semi-cured films in Examples 1 and 2 and the cholesteric liquid crystal films in Comparative Examples 1 and 2) at 130° C. was measured using a TENSILON universal material testing machine (RTC-1225A, manufactured by A&D Company). An elongation at break of 10% or more is practically preferable.

The results of each measurement are collectively shown in Table 1 below.

In Table 1, “presence or absence of cracks” indicates whether or not cracks are observed in the CL film (cured film) in a case where the film is laminated on the curved glass.

In each of Examples 1 and 2 and Comparative Examples 1 and 2, the obtained cured film corresponded to a film in which the cholesteric liquid crystalline phase was fixed.

TABLE 1

| | Presence or | Modulus of | Elongation at |
|---|---|---|---|
| | absence of cracks | elasticity | break |
| Example 1 | Absence | A | 26% |
| Example 2 | Absence | A | 10% |
| Comparative | Presence | A | 5% |
| Example 1 | | | |
| Comparative | Absence | B | 25% |
| Example 2 | | | |

As shown in Table 1, according to the production method of the present invention, it was possible to produce a CL film having a high modulus of elasticity and having a predetermined shape without cracks. Among these, in Example 1 in which the liquid crystal compound A having the first reactive group and the second reactive group different from the first reactive group was used, the elongation at break was high and the more excellent effect was exhibited.

On the other hand, in Comparative Examples 1 and 2 in which the stepwise curing treatment was not carried out, the CL film was cracked or the modulus of elasticity of the CL film was low.

In addition, in Examples 1 and 2 described above, the operation of performing a curing treatment on the coating film formed by further applying the composition 1 (or the composition 2) onto the obtained semi-cured film by the same procedure as described above was repeated. However, by carrying out the same procedure as in Examples 1 and 2, a CL film having a thickness of about 2 to 5 μm and exhibiting a predetermined effect was obtained.

What is claimed is:

1. A method for producing a cholesteric liquid crystal film comprising:
step 1 of forming a coating film which includes a liquid crystal compound A having a first reactive group and a second reactive group that is different from the first reactive group or which includes a liquid crystal compound B having the first reactive group and a liquid crystal compound C having the second reactive group;
step 2 of forming a cholesteric liquid crystalline phase in the coating film;
step 3 of allowing the first reactive group to react to cure the coating film;
step 4 of forming the coating film obtained in the step 3; and
following step 4, step 5 of allowing the second reactive group to react to produce a cholesteric liquid crystal film.

2. The method for producing a cholesteric liquid crystal film according to claim 1,
wherein the first reactive group and the second reactive group are each independently selected from the group consisting of an acryloyl group, a methacryloyl group, an oxetanyl group, an epoxy group, a thietanyl group, a thioepoxy group, a carboxyl group, a mercapto group, an isocyanate group, an isothiocyanate group, an aziridinyl group, a pyrrole group, a vinyl group, an allyl group, a fumarate group, a cinnamoyl group, an oxazoline group, a hydroxyl group, an alkoxysilyl group, a hydrosilyl group, and an amino group.

3. The method for producing a cholesteric liquid crystal film according to claim 1,
wherein the coating film in the step 1 includes a chiral agent.

4. The method for producing a cholesteric liquid crystal film according to claim 1,
wherein the reaction of the second reactive group is a radical polymerization reaction.

5. The method for producing a cholesteric liquid crystal film according to claim 1,
wherein the second reactive group is an acryloyl group or a methacryloyl group.

6. The method for producing a cholesteric liquid crystal film according to claim 1,
wherein the reaction of the first reactive group is a cationic polymerization reaction, a Michael addition reaction, a hydrosilylation reaction, or an ene-thiol reaction.

7. The method for producing a cholesteric liquid crystal film according to claim 1,
wherein the first reactive group is an oxetanyl group, an epoxy group, a thietanyl group, a thioepoxy group, a mercapto group, an acryloyl group, or a methacryloyl group.

8. The method for producing a cholesteric liquid crystal film according to claim 1,
wherein the coating film in the step 1 includes the liquid crystal compound A having the first reactive group and the second reactive group that is different from the first reactive group.

9. The method for producing a cholesteric liquid crystal film according to claim 2,
wherein the coating film in the step 1 includes a chiral agent.

10. The method for producing a cholesteric liquid crystal film according to claim 2,
wherein the reaction of the second reactive group is a radical polymerization reaction.

11. The method for producing a cholesteric liquid crystal film according to claim 2,
wherein the second reactive group is an acryloyl group or a methacryloyl group.

12. The method for producing a cholesteric liquid crystal film according to claim 2,
wherein the reaction of the first reactive group is a cationic polymerization reaction, a Michael addition reaction, a hydrosilylation reaction, or an ene-thiol reaction.

13. The method for producing a cholesteric liquid crystal film according to claim 2,
wherein the first reactive group is an oxetanyl group, an epoxy group, a thietanyl group, a thioepoxy group, a mercapto group, an acryloyl group, or a methacryloyl group.

14. The method for producing a cholesteric liquid crystal film according to claim 2,
wherein the coating film in the step 1 includes the liquid crystal compound A having the first reactive group and the second reactive group that is different from the first reactive group.

15. The method for producing a cholesteric liquid crystal film according to claim 3,
wherein the reaction of the second reactive group is a radical polymerization reaction.

16. The method for producing a cholesteric liquid crystal film according to claim 3,
wherein the second reactive group is an acryloyl group or a methacryloyl group.

17. The method for producing a cholesteric liquid crystal film according to claim 3,
wherein the reaction of the first reactive group is a cationic polymerization reaction, a Michael addition reaction, a hydrosilylation reaction, or an ene-thiol reaction.

18. The method for producing a cholesteric liquid crystal film according to claim 3,
wherein the first reactive group is an oxetanyl group, an epoxy group, a thietanyl group, a thioepoxy group, a mercapto group, an acryloyl group, or a methacryloyl group.

19. The method for producing a cholesteric liquid crystal film according to claim 3,
wherein the coating film in the step 1 includes the liquid crystal compound A having the first reactive group and the second reactive group that is different from the first reactive group.

20. The method for producing a cholesteric liquid crystal film according to claim 4,
wherein the second reactive group is an acryloyl group or a methacryloyl group.
